(19) United States
(12) Patent Application Publication
(10) Pub. No.: US 2008/0182516 A1
(43) Pub. Date: Jul. 31, 2008

(54) INFORMATION PROCESSING APPARATUS AND CONTROLLING METHOD OF THE SAME

(75) Inventor: Yasuo Yamada, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/019,233

(22) Filed: Jan. 24, 2008

(30) Foreign Application Priority Data
Jan. 31, 2007 (JP) 2007-022254

(51) Int. Cl. H04B 7/00

(52) U.S. Cl. 455/41.2

(57) ABSTRACT

According to one embodiment, an information processing apparatus, includes a changing unit which, if a command transmitted from a short-distance wireless communications terminal by pushing down a volume control button is received in a standby status in which the short-distance wireless communications terminal makes no connection with the Internet Protocol telephone communications network, changes selection of the telephone number stored in a memory unit, and a calling unit which, if a command transmitted from the short-distance wireless communications terminal by pushing down a call button is received after the changing process of the changing unit, calls the selected telephone number.

### CROSS-REFERENCE TO RELATED APPLICATIONS

This application is based upon and claims the benefit of priority from Japanese Patent Application No. 2007-022254, filed Jan. 31, 2007, the entire contents of which are incorporated herein by reference.

### BACKGROUND

1. Field

One embodiment of the invention relates to an information processing apparatus such as a personal computer establishing wireless communications with a short-distance wireless terminal, and a controlling method of the information processing apparatus.

2. Description of the Related Art

In general, handsfree terminals employing wireless connection have been developed. The handsfree terminals are configured to establish wireless connection with cellular telephones, personal computers and the like and make conversation. Some of commercially available handsfree terminals are mounted on ears when they are used.

Each of the handsfree terminals comprises a redial button. On the basis of the number of times of pushing down the redial button 101, previously dialed telephone numbers are changed. When a desired telephone number is displayed, dialing is executed by pushing down a conversation button (cf. Jpn. Pat. Appln. KOKAI Publication No. 10-200621).

According to the technique of Jpn. Pat. Appln. KOKAI Publication No. 10-200621, however, a preliminarily registered telephone number cannot be dialed. In addition, it is indispensable to confirm the redialed telephone number on a display screen.

### BRIEF DESCRIPTION OF THE SEVERAL VIEWS CF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing a handsfree set and an information processing apparatus according to an embodiment of the present invention;

FIG. 2 is a block diagram showing a system configuration of an information processing apparatus according to the embodiment of the present invention;

FIG. 3 is a block diagram showing functions of a VOIP-associated application;

FIG. 4 is an illustration of the handsfree set;

FIG. 5 is an illustration showing a list of telephone numbers of preliminarily registered connection correspondents; and

FIG. 6 is a flowchart of a control method and program to which the information processing apparatus according to the embodiment of the present invention is applied.

### DETAILED DESCRIPTION

Various embodiments according to the invention will be described hereinafter with reference to the accompanying drawings. In general, according to one embodiment of the invention, an information processing apparatus, comprises: a volume control button and a call button; a communications unit which establishes wireless communications with a short-distance wireless communications terminal; a connecting unit which makes connection with an Internet Protocol telephone communications network; a memory unit which stores a plurality of telephone numbers of call recipients; a changing unit which, if a command transmitted from the short-distance wireless communications terminal by pushing down the volume control button is received in a standby status in which the short-distance wireless communications terminal makes no connection with the Internet Protocol telephone communications network, changes selection of the telephone number stored in the memory unit; and a calling unit which, if a command transmitted from the short-distance wireless communications terminal by pushing down the call button is received after the changing process of the changing unit, calls the selected telephone number.

An embodiment of the present invention will be described with reference to the accompanying drawings.

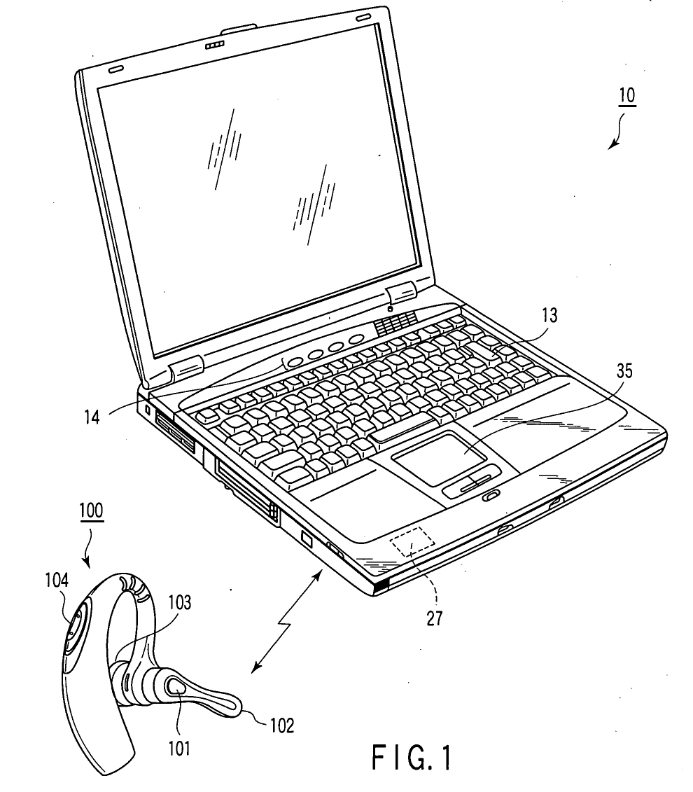

A main body of a computer 10 is a housing shaped in a thin box and comprises, on a top face thereof, a keyboard 13, a touch pad 35, two right and left buttons, various kinds of shortcut buttons for mailing and the like, a volume control button, a power button 14, a speaker and the like, as shown in FIG. 1. An optical drive and the like are provided on side faces of the main body. A Bluetooth™ communications unit 27 for executing short-distance wireless communications is built in the palm rest. For the short-distance wireless communications, Bluetooth™ is employed in this embodiment but the other wireless connection methods of wireless LAN and the like may be employed.

One of devices executing connection via the Bluetooth™ communications unit 27 is, for example, a handsfree set 100. A Bluetooth™ communications unit (not shown) is built in the handsfree set 100, similarly to the computer 10. The handsfree set 100 comprises a redial button 101, a microphone 102, a speaker 103, a volume control button 104 and the like. The volume control button 104 has, for example, a volume-up (gain-up) button on an upper side and a volume-down (gain-down) button on a lower side. In the present embodiment, the short-distance wireless communications terminal is the handsfree set 100 but is not limited to this. The same advantage can also be obtained from any terminal comprising a volume control button, a button corresponding to the outgoing button, and the handsfree profile, such as a headset or the like.

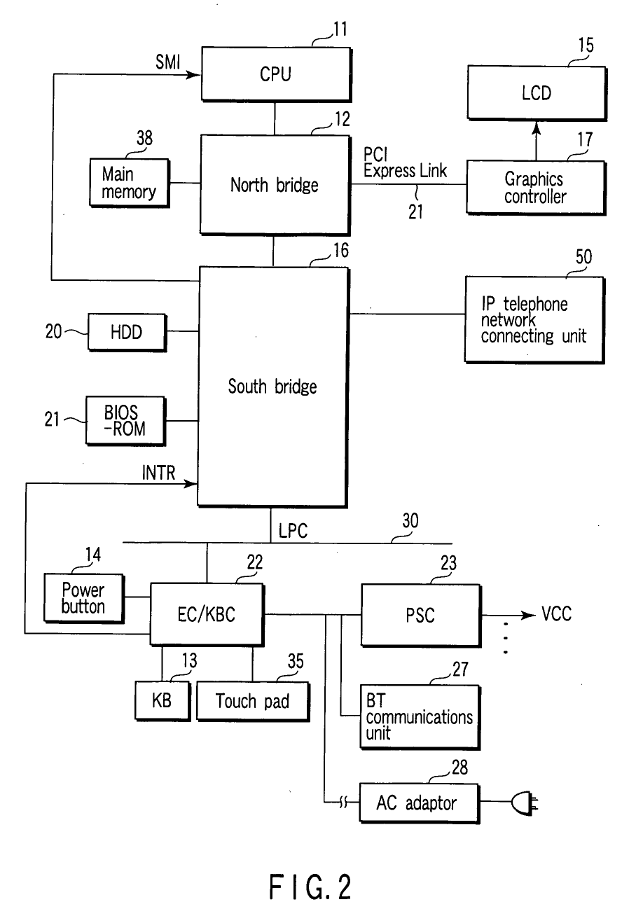

FIG. 2 is a block diagram showing a configuration of the computer 10.

As shown in the figure, the personal computer 10 comprises a CPU (Central Processing Unit) 11, a north bridge 12, a main memory 38, a graphics controller 17, a display unit (LCD) 15, a south bridge 16, a hard disk drive (HDD) 20, a BIOS-ROM 21, an embedded controller/keyboard controller IC (EC/KBC) 22, a power supply controller (PSC) 23, the keyboard (KB) 13, the touch pad 35, the Bluetooth (registered trademark) communications unit (hereinafter called BT communications unit) 27 which establishes short-distance wireless communications, an IP (Internet Protocol) telephone network connecting unit 50 and the like. The HDD 20 stores a VOIP (Voice Over Internet Protocol)-associated application to be described later, telephone numbers of correspondents, and the like. The IP telephone connections are controlled via the IP telephone network connecting unit 50.

Each of the north bridge 12, the graphics controller 17 and the south bridge 16 is a device (component) which is in conformity with the PCI EXPRESS standards. The communications between the north bridge 12 and the graphics controller 17 are executed over the PCI Express Link 21 arranged between the north bridge 12 and the graphics controller 17. Each of PCI EXPRESS links is a communications path composed of a serial interface, and includes an upstream lane and a downstream lane.

The CPU 11 is a processor controlling the operations of the computer, and executes various kinds of programs (operating system, VOIP application programs and the like) loaded on the main memory 38 by the HDD 20. The CPU 11 also executes the BIOS (Basic Input Output System) stored in the BIOS-ROM 21. The BIOS is a program for controlling the hardware. In addition, the BIOS has an SMI (System Management Interrupt) routine for dynamically permitting or prohibiting the execution of the Active State Power Management (ASPM) function defined under the PCI Express standards in accordance with the operation mode of the computer.

The north bridge 12 is a bridge device for making a connection between a local bus of the CPU 11 and the south bridge 16. A memory controller for controlling access to the main memory 38 is built in the north bridge 12. The north bridge 12 also has a function of executing communications with the graphics controller 17 over the PCI EXPRESS link 21.

The graphics controller 17 is a display controller which controls the LCD 15 employed as a display monitor of the computer. The south bridge 16 also controls each of the devices such as the BT communications unit 27 on an LPC (Low Pin Count) bus 30.

The embedded controller/keyboard controller IC (EC/KBC) 22 is a one-chip microcomputer on which an embedded controller for power management and a keyboard controller controlling the keyboard (KB) 13 and the touch pad 35 are integrated. The embedded controller/keyboard controller IC (EC/KBC) 22 has a function of controlling power-on/power-off of the computer 10, in cooperation with the power supply controller (PSC) 23, in response to the user's operation of the power button 24. Moreover, the embedded controller/keyboard controller IC (EC/KBC) 22 also has a function of detecting connection of an AC adaptor 28 to the computer or detachment of the AC adaptor 28 from the computer.

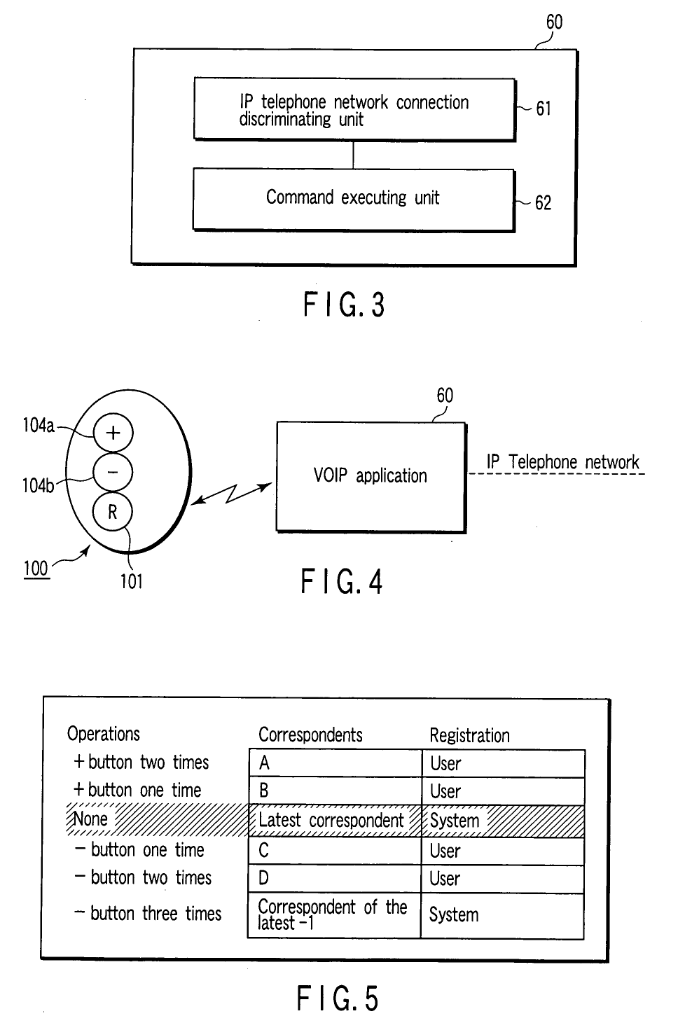

FIG. 3 is a block diagram showing functions of the VOIP-associated application 60 loaded on the main memory 38 and executed by the CPU 11.

The VOIP-associated application 60 comprises an IP telephone network connection discriminating unit 61 and a command executing unit 62. The IP telephone network connection discriminating unit 61 discriminates whether the handsfree set 100 is connected to the IP telephone network via the BT communications unit 27 and the IP telephone connecting unit 50. In other words, the IP telephone network connection discriminating unit 61 discriminates whether the handsfree set 100 is currently employed for conversation or waiting in a standby status. The command executing unit 62 executes a command received from the handsfree set 100. For example, FIG. 4 illustrates the handsfree set 100 and the like. The handsfree set 100 comprises a volume up button 104a and a volume down button 104b.

In a case where the volume the up button 104a is pushed down and the VOIP-associated application 60 of the computer 10 thereby receives a volume up command from the handsfree set 100, if the handsfree set 100 is in communications, the VOIP-associated application 60 reads speaker gain value information from the handsfree set 100 and turns up the volume on the basis of the gain value information. If the handsfree set 100 is in the standby status, the VOIP-associated application 60 changes selection of the correspondent telephone numbers stored in the HDD 20. The correspondent telephone numbers stored in the HDD 20 are preliminarily registered, and a plurality of telephone numbers can be registered as the correspondent telephone numbers. These telephone numbers are assigned orders, and the change of selection is executed in accordance with the orders. For example, as shown in FIG. 5, A-D, the latest correspondent (standard default position: always returning to this position after conversations, and the latest correspondent −1 (second latest correspondent) are registered as the correspondent telephone numbers.

For example, if the volume up command is received, selection is changed from “latest correspondent (standard default position)” to plus (+) direction. If the volume down command is received, the selection is changed to minus (−) direction. The selected telephone number can be displayed on the LCD 51, and the display can be set to be off. In addition, the currently selected position is colored and can easily be recognized as shown in FIG. 5. The voice mail reproducing function may be registered instead of the correspondent telephone numbers.

In a case where the bottom of the list of the registered correspondent telephone numbers, for example, “A” is selected, if a selection change command (volume up command) is further received, “A” is changed to the opposite side in the list of the registered correspondent telephone numbers (“correspondent of the latest −1”) on the basis of, for example, the round robin scheduling. Similarly, if the bottom of the list of the registered correspondent telephone numbers is, for example, “correspondent of the latest −1” and the volume down command is further received, “correspondent of the latest −1” is changed to the opposite side in the list of the registered correspondent telephone numbers (“A”). (The selected position can be set not to transfer from the bottom of the list to the opposite side and stay at the bottom of the list.)

If the volume up button 104a is pushed down and the volume up command is thereby received while the handsfree set 100 is in the standby status, for example, the selection of the correspondent telephone number is selected from the “latest correspondent” to the plus (+) direction (predetermined order). In other words, the “latest correspondent” is changed to “B”. On the other hand, if the volume down button 104b is pushed down and the volume down command is thereby received while the handsfree set 100 is in the standby status, for example, the selection of the correspondent telephone number is selected from the “latest correspondent” to the minus (−) direction (order opposite to the predetermined order). In other words, the “latest correspondent” is changed to “C”. If the command generated by pushing down the redial button 101 after the volume up button or volume down button is received, the selected correspondent is called.

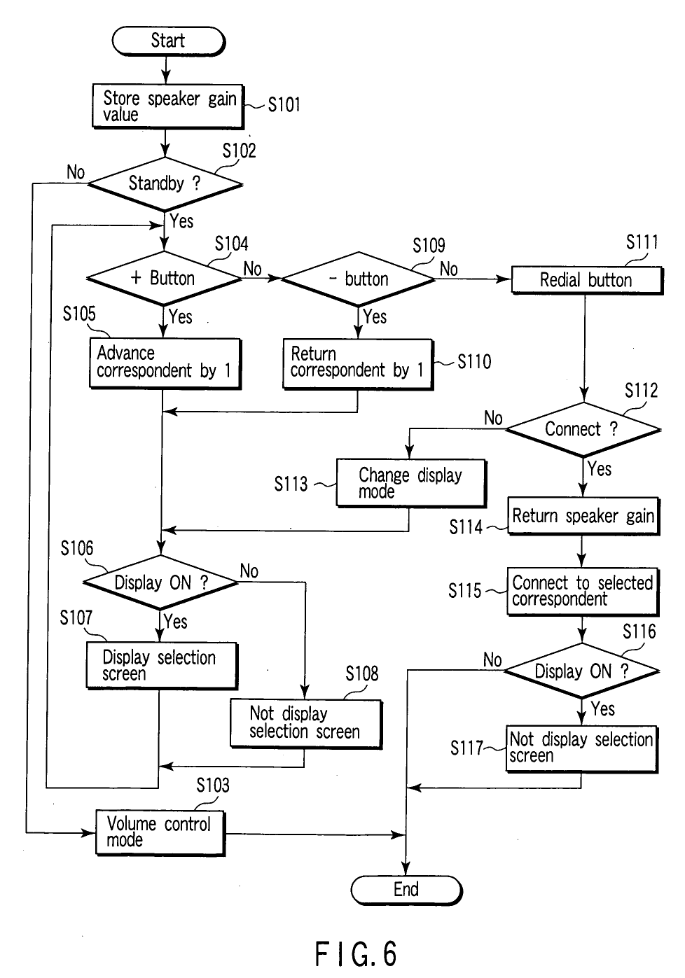

Next, a control method and a program to which the information processing apparatus according to the embodiment of the present invention will be described with reference to a flowchart of FIG. 6.

The VoIP-associated application 60 stores the current speaker gain value in the HDD 20 or the like (step S101), to be in a multiple wait status which is a standby status to wait an input key. It is discriminated by the IP telephone network connection discriminating unit 61 of the VOIP-associated application 60 whether the handsfree set 100 is connected to the IP telephone network via the BT communications unit 27 and the IP telephone connecting unit 50 (step S102). If it is discriminated by the VOIP-associated application 60 that the handsfree set 100 is connected to the IP telephone network, the VOIP-associated application 60 shifts to the volume control mode (step S103). If the volume up command generated by pushing down the volume up button is received from the handsfree set 100, the stored speaker gain value is read and the volume of the speaker of the handsfree set 100 is turned down by the predetermined value on the basis of the speaker gain value. Furthermore, if the dial command generated by pushing down the redial button 101 is received from the handsfree set 100, the previous correspondent as stored is read and dialed.

On the other hand, if it is discriminated by the VOIP-associated application 60 in step S102 that the handsfree set 100 is not connected to the IP telephone network (i.e. in the standby status), and if the volume up command generated by pushing down the volume up (+) button 104a is received from the handsfree set 100 in step S104, the selection of the telephone number is changed, for example, by one step to the plus (+) direction by the command executing unit 62 (step S105: cf. FIG. 5). The default selection position is a position where the latest correspondent is registered as shown in FIG. 5, and the position is always set at the default selection position after conversation.

Next, if the display settings of the registered telephone number and the selected telephone number are turned on (YES in step S106), the selection screen and the like are displayed as shown in FIG. 5 (step S107). If the display settings of the registered telephone number and the selected telephone number are turned off (NO in step S106), the selection screen and the like are not displayed (step S108).

If the received command is not the volume up command transmitted from the handsfree set 100 and generated by pushing down the volume up (+) button 104a, in step S104 (NO in step S104), but if the volume down command transmitted from the handsfree set 100 and generated by pushing down the volume down (−) button 104b is received (YES in step S109), the selection of the telephone number is changed, for example, by one step to the minus (−) direction by the command executing unit 62 (step S110: cf. FIG. 5). In addition, if the received command is not the volume down command transmitted from the handsfree set 100 and generated by pushing down the volume down (−) button 104b, in step S109 (NO in step S109), but if the redial command transmitted from the handsfree set 100 and generated by pushing down the redial button 101 is received (step S111), it is discriminated whether the connection to the IP telephone network is executed (step S112). If the VOIP-associated application 60 does not connect to the IP telephone network in accordance with the input direction from the user (NO in step S112), the display mode is changed (step S113) and the operation shifts to step S106. On the other hand, if the VOIP-associated application 60 connects to the IP telephone network in step S112, the VOIP-associated application 60 changes the speaker gain value of the speaker 103 of the handsfree set 100 to, for example, 7 of 10 steps as the default value (step S114) and connects to the selected correspondent (step S115). If the commands generated by pushing down the volume buttons are not received, the default selection position is selected as shown in FIG. 5, the redial command generated by pushing down the redial button is received and the previously dialed correspondent is dialed by the command executing unit 62.

Next, if the display of the list of the registered correspondent telephone numbers and the selected telephone number is turned on (YES in step S116), the display is not displayed (step S117) and the operation is ended. If the display of the list of the registered correspondent telephone numbers and the selected telephone number is not turned on (NO in step S116), the operation is ended.

According to the present invention as described above, the registered telephone number can be dialed by a simple operation, with the minimum button mounted on the short-distance wireless communications terminal such as a handsfree terminal or the like.

The present invention is not limited to the embodiments described above but the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a volume control button and a call button;
a communications unit which establishes wireless communications with a short-distance wireless communications terminal;
a connecting unit which makes connection with an Internet Protocol telephone communications network;
a memory unit which stores a plurality of telephone numbers of call recipients;
a changing unit which, if a command transmitted from the short-distance wireless communications terminal by pushing down the volume control button is received in a standby status in which the short-distance wireless communications terminal makes no connection with the Internet Protocol telephone communications network, changes selection of the telephone number stored in the memory unit; and
a calling unit which, if a command transmitted from the short-distance wireless communications terminal by pushing down the call button is received after the changing process of the changing unit, calls the selected telephone number.

2. The apparatus according to claim 1, wherein the call button is a redial button.

3. The apparatus according to claim 1, wherein the volume control button is composed of a volume up button and a volume down button, selection of the plurality of telephone numbers is changed in a predetermined order if the volume up button is pushed down, and the selection of the plurality of telephone numbers is changed in an order opposite to the predetermined order if the volume down button is pushed down.

4. The apparatus according to claim 3, wherein in a case where the selection of the plurality of telephone numbers is changed in the predetermined order or the order opposite to the predetermined order, if the selection comes to a last part of the order, the selection returns to a first part of the order.

5. The apparatus according to claim 1, wherein the communications unit has a connection mode employing Bluetooth standards.

6. The apparatus according to claim 1, wherein the short-distance wireless communications terminal is a terminal comprising a handsfree profile.

7. A method of controlling an information processing apparatus comprising a volume control button and a call button, a communications unit which establishes wireless communications with a short-distance wireless communications terminal, a connecting unit which makes connection with an Internet Protocol telephone communications network, and a memory unit which stores a plurality of telephone numbers of call recipients,
the method comprising:
a changing step of, if a command transmitted from the short-distance wireless communications terminal by pushing down the volume control button is received in a standby status in which the short-distance wireless communications terminal makes no connection with the Internet Protocol telephone communications network, changing selection of the telephone number stored in the memory unit; and
a calling step of, if a command transmitted from the short-distance wireless communications terminal by pushing down the call button is received after the changing process of the changing unit, calling the selected telephone number.
